(19) United States
(12) Patent Application Publication
(10) Pub. No.: US 2009/0095257 A1
(43) Pub. Date: Apr. 16, 2009

(54) FUEL INJECTION SYSTEM WITH HIGH-PRESSURE FUEL RESERVOIR AND GAP FILTER AS PRESSURE VIBRATION DAMPER

(76) Inventors: Wolfgang Buchhauser, Teugn (DE); Adolf Einberger, Rimbach (DE); Christoph Klesse, Worth A.D.Donau (DE); Georg Weigl, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/293,941

(22) PCT Filed: Mar. 8, 2007
(86) PCT No.: PCT/EP07/52166

§ 371 Date: Nov. 5, 2008

(30) Foreign Application Priority Data
Mar. 27, 2006 (DE) 10 2006 014 035.4

(51) Int. Cl. F02M 37/22; F02M 55/02; F02M 61/16

(52) U.S. Cl. 123/445; 137/544; 210/416.4; 123/456

(57) ABSTRACT

A fuel injection system has a high-pressure fuel reservoir with at least one fuel feed and at least one fuel discharge, wherein the fuel feed interacts with a high-pressure fuel pump and the fuel discharge interacts with a fuel injection valve. Arranged in the fuel discharge and/or fuel feed of the high-pressure fuel reservoir is a gap filter which is configured geometrically in such a way that it achieves a predetermined throttle effect. The use of the gap filter in the fuel discharge and/or in the fuel feed prevents dirt particles from being able to get into the injector and cause malfunctions there. Furthermore, pressure vibrations which are induced in the system as a result of the injection process or as a result of the high-pressure fuel pump are damped by the throttle effect of the gap filter.

### CROSS-REFERENCE TO RELATED APPLICATIONS

This application is a U.S. National Stage Application of International Application No. PCT/EP2007/052166 filed Mar. 8, 2007, which designates the United States of America, and claims priority to German Application No. 10 2006 014 035.4 filed Mar. 27, 2006, the contents of which are hereby incorporated by reference in their entirety.

### TECHNICAL FIELD

The invention relates to a fuel injection system comprising a high-pressure fuel reservoir having at least one fuel inlet and at least one fuel outlet, the fuel inlet operatively interacting with a high-pressure fuel pump and the fuel outlet operatively interacting with a fuel injection valve.

### BACKGROUND

Fuel injection systems of this kind are also referred to as common-rail systems and are in widespread use today in motor vehicles powered by diesel engines. With such systems the high-pressure fuel pump compresses the diesel fuel to pressures of currently up to 1800 bar. Exceptionally high mechanical demands are imposed on the high-pressure pump on account of the high pressures. Due to the mechanical stress on the high-pressure fuel pump mechanical abrasion occurs particularly in the region of the piston, resulting in abrasion debris (dirt particles) which can reach the fuel injection valve via the fuel line and the high-pressure fuel reservoir. Although the dirt particles are typically very small, even the finest dirt particles (less than 2μ) can lead to malfunctions at the injector. The dirt particles deposit themselves in this case between the nozzle needle and the valve seat and prevent the injector from closing completely. As a result fuel continually infiltrates the combustion chamber of the internal combustion engine. A clean injection is consequently not possible and the pollutant emissions increase substantially. In order to prevent this, gap-type filters are often positioned at the input of the injector. The gap-type filters are also able to filter out the minutest dirt particles from the fuel system and thereby prevent the dirt particles being able to deposit themselves in the region of the needle seat.

A further problem which frequently occurs with modern fuel injection systems having high-pressure fuel reservoirs is that because of the single or multiple injection at the injector pressure oscillations are triggered which propagate upstream and affect the precision of the injection quantity. Said pressure oscillations are compensated on the one hand by software and by means of a TI control correction function which is stored in the control device, and on the other hand via a restrictor which is preferably disposed at the rail output and thus effects a damping of the pressure oscillations. As the measures described require on the one hand a considerable assembly and installation effort and on the other hand a technical overhead in terms of optimization of the software, a way of overcoming the aforesaid problems in a simpler manner is sought.

### SUMMARY

Dirt particles may be kept away from the injector by simple means and pressure oscillations caused by the injection may be damped.

According to an embodiment, a fuel injection system may comprise a high-pressure fuel reservoir having at least one fuel inlet and at least one fuel outlet, the fuel inlet operatively interacting with a high-pressure fuel pump and the fuel outlet operatively interacting with a fuel injection valve, wherein a gap-type filter is disposed in at least one of the fuel outlet and in the fuel inlet of the high-pressure fuel reservoir, said gap-type filter being embodied geometrically in such a way that it achieves a predefined restricting effect.

According to a further embodiment, the gap-type filter can be integrated in a high-pressure adapter and disposed together with the high-pressure adapter in at least one of the fuel outlet and in the fuel inlet of the high-pressure fuel reservoir. According to a further embodiment, the high-pressure adapter can be embodied as a standard part.

### BRIEF DESCRIPTION OF THE DRAWINGS

Exemplary embodiments and further advantages of the invention are explained below with reference to the drawing, in which:

FIG. 1: schematically shows a high-pressure fuel reservoir having gap-type filters in the fuel outlet and in the fuel inlet; and

FIG. 2: is a schematic detailed view of a high-pressure fuel reservoir in which the gap-type filter is integrated in a high-pressure adapter and is disposed together with the high-pressure adapter in the fuel outlet.

In the following description identical or functionally identical components are identified by the same reference signs.

### DETAILED DESCRIPTION

The fuel injection system according to an embodiment may comprise a high-pressure fuel reservoir having at least one fuel inlet and at least one fuel outlet, the fuel inlet operatively interacting with a high-pressure fuel pump and the fuel outlet operatively interacting with a fuel injection valve, is characterized in that a gap-type filter is disposed in the fuel outlet and/or in the fuel inlet of the high-pressure fuel reservoir, said gap-type filter being embodied geometrically in such a way that it achieves a predefined restricting effect. Owing to the embodiment and arrangement of the gap-type filter it is therefore possible by means of a single component not only to protect the injector against contamination but also, due to the simultaneous restricting effect of the gap-type filter, to reduce the pressure oscillations in the fuel injection system and thereby increase the injection quantity precision. Owing to the fact that only one component is henceforth required for solving the above-described problems, the costs of the fuel injection system can be substantially reduced. Furthermore the gap-type filter is very robust and as a result is not prone to malfunctions.

An embodiment of the fuel injection system provides that the gap-type filter is integrated in a high-pressure adapter and disposed together with the high-pressure adapter in the fuel outlet and/or in the fuel inlet of the high-pressure fuel reservoir. In this arrangement the high-pressure adapter can particularly advantageously be embodied as a standard part. As a result of disposing the gap-type filter in the high-pressure adapter its secure mounting in the high-pressure fuel reservoir is made easier. Mounting the gap-type filter in the high-pressure adapter prior to assembly also simplifies the assembly and installation of the fuel injection system.

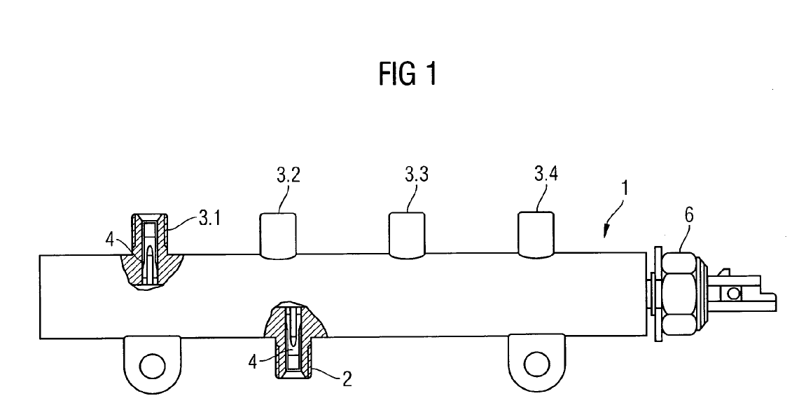

FIG. 1 shows a high-pressure fuel reservoir 1 in a simplified representation. The high-pressure fuel reservoir 1 is embodied as an elongate hollow body. The high-pressure fuel reservoir 1 has a fuel inlet 2. The fuel inlet operatively interacts by way of an inlet line (not shown in further detail) with a high-pressure fuel pump (also not shown). The high-pressure fuel pump compresses the fuel and feeds it into the high-pressure fuel reservoir 1. The pressure in the high-pressure fuel reservoir 1 is controlled via a pressure regulating valve 6. In addition the high-pressure fuel reservoir 1 has a plurality (4 in total in the exemplary embodiment) of fuel outlets 3.1; 3.2; 3.3 and 3.4. Each fuel outlet is connected to a fuel injection valve via a fuel line (also not shown). A first gap-type filter 4 is disposed in the fuel inlet 2. The gap-type filter 4 prevents contaminants, in particular mechanical abrasion debris of the high-pressure fuel pump, from being able to penetrate into the high-pressure fuel reservoir 1 and from there being able to progress further to the fuel injectors and there cause malfunctions of the fuel injection valve. Furthermore the gap-type filter 4 is embodied geometrically in such a way that it achieves a predefined restricting effect. Said restricting effect can damp pressure fluctuations that are generated due to the high-pressure fuel pump and introduced into the system. Gap-type filters 4 are likewise used in the fuel outlets 3.1; 3.2; 3.3 and 3.4. The gap-type filters 4 in turn ensure that contaminants from the rail cannot progress further via the outlet lines to the fuel valves. The contaminants can be present either because they have managed to pass the first gap-type filter 4 or they can be contaminants which accumulated during the manufacture of the high-pressure fuel reservoir 1 and were not completely removed during the subsequent cleaning prior to assembly and installation. The gap-type filter 4 in the fuel outlets 3.1; 3.2; 3.3 and 3.4 is embodied geometrically in such a way that it in turn achieves a predefined restricting effect. The restricting effect is configured in such a way that pressure fluctuations that are generated by the injection process, that is to say due to the opening and injecting of the fuel into the combustion chamber, cannot propagate into the entire fuel injection system, but are effectively damped by the gap-type filter 4 at the output or at the fuel outlet 3.1; 3.2; 3.3 and 3.4 and consequently cannot propagate into the parallel branches to the other fuel injection valves. The injection precision of the entire fuel system is increased as a result. By means of the gap-type filter in the fuel inlet 2 it may be possible to do without additional restrictors at the high-pressure fuel pump. Said restrictors are often used at the output of the high-pressure fuel pump in order to reduce the pulsation oscillations of the high-pressure fuel pump that are due to its design.

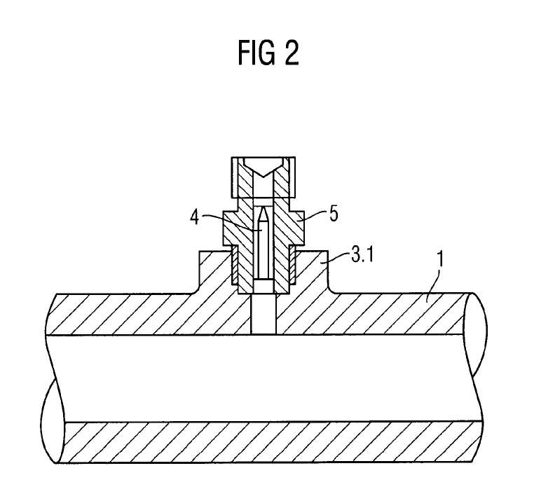

FIG. 2 shows a detailed view of a high-pressure fuel reservoir 1 in which a high-pressure adapter 5 is used in the fuel outlet 3.1. A high-pressure adapter 5 of this kind is available as a standard part and serves to connect the outlet line to the fuel injection system reliably and securely to the high-pressure fuel reservoir 1. A gap-type filter 4 is used in the high-pressure adapter 5. The gap-type filter 4 is introduced prior to the assembly and installation of the high-pressure adapter 5 on the high-pressure reservoir 1. This considerably simplifies the assembly and installation of the fuel injection system.

The gap-type filter 4 is preferably mounted in the high-pressure adapter 5 or, as the case may be, directly in the fuel outlet 3.1; 3.3; 3.3 and 3.4 or in the fuel inlet 2 by force fitting. In this way the gap-type filter is securely mounted in a particularly simple manner.

As a result of the gap-type filter 4 being disposed in the fuel outlet 3.1; 3.2; 3.3 and 3.4 and/or in the fuel inlet 2 two existing problems in the operation of the fuel injection system are avoided or at least mitigated in a particularly simple and inexpensive way. On the one hand the gap-type filter 4 prevents dirt particles from penetrating into the fuel injection valve and consequently malfunctions from occurring during the closing of the injection needle, and on the other hand a restricting effect which can damp pressure fluctuations is achieved as a result of the corresponding geometric embodiment of the gap-type filter 4. Such pressure fluctuations can be caused either by the injection process or by the high-pressure fuel pump. The proposed solution thus provides a very precise control of injection quantities and ensures reliable operation of the fuel injection system as well as a long useful life.

What is claimed is:

1. A fuel injection system comprising a high-pressure fuel reservoir having at least one fuel inlet and at least one fuel outlet, the fuel inlet operatively interacting with a high-pressure fuel pump and the fuel outlet operatively interacting with a fuel injection valve, wherein
a gap-type filter is disposed in at least one of the fuel outlet and in the fuel inlet of the high-pressure fuel reservoir, said gap-type filter being embodied geometrically in such a way that it achieves a predefined restricting effect.

2. The fuel injection system according to claim 1, wherein
the gap-type filter is integrated in a high-pressure adapter and disposed together with the high-pressure adapter in at least one of the fuel outlet and in the fuel inlet of the high-pressure fuel reservoir.

3. The fuel injection system according to claim 2, wherein
the high-pressure adapter is embodied as a standard part.

4. The fuel injection system according to claim 1, wherein the at least one fuel inlet is arranged on the opposite side the at least one fuel outlet.

5. The fuel injection system according to claim 1, wherein a pressure in the high-pressure fuel reservoir is controlled via a pressure regulating valve.

6. A method for distributing fuel in a fuel injection system comprising the steps of:
providing a high-pressure fuel reservoir having at least one fuel inlet and at least one fuel outlet, the fuel inlet operatively interacting with a high-pressure fuel pump and the fuel outlet operatively interacting with a fuel injection valve, and
disposing a gap-type filter in at least one of the fuel outlet and in the fuel inlet of the high-pressure fuel reservoir, said gap-type filter being embodied geometrically in such a way that it achieves a predefined restricting effect.

7. The method according to claim 6, further comprising the step of integrating the gap-type filter in a high-pressure adapter and disposing the gap-type filter together with the high-pressure adapter in at least one of the fuel outlet and in the fuel inlet of the high-pressure fuel reservoir.

8. The method according to claim 7, wherein the high-pressure adapter is embodied as a standard part.

9. The method according to claim 6, further comprising the step of arranging the at least one fuel inlet on the opposite side the at least one fuel outlet.

10. The method according to claim 6, further comprising the step of controlling a pressure in the high-pressure fuel reservoir via a pressure regulating valve.

11. A fuel injection system comprising a high-pressure fuel reservoir having at least one fuel inlet and at least one fuel outlet, the fuel inlet operatively interacting with a high-pressure fuel pump and the fuel outlet operatively interacting with a fuel injection valve, wherein a gap-type filter is disposed in the at least one fuel outlet and in the at least one fuel inlet of the high-pressure fuel reservoir, said gap-type filter being embodied geometrically in such a way that it achieves a predefined restricting effect.

12. The fuel injection system according to claim 11, wherein the gap-type filter is integrated in a high-pressure adapter and disposed together with the high-pressure adapter in the at least one fuel outlet and in the at least one fuel inlet of the high-pressure fuel reservoir.

13. The fuel injection system according to claim 12, wherein the high-pressure adapter is embodied as a standard part.

14. The fuel injection system according to claim 11, wherein the at least one fuel inlet is arranged on the opposite side the at least one fuel outlet.

15. The fuel injection system according to claim 11, wherein a pressure in the high-pressure fuel reservoir is controlled via a pressure regulating valve.
